(19) United States
(12) Patent Application Publication
(10) Pub. No.: US 2026/0274014 A1
(43) Pub. Date: Sep. 17, 2026

(54) INTEGRATED VALVE CORE DEPRESSOR IN TIRE PRESSURE MONITORING SYSTEM

(71) Applicant: SmartWitness USA, LLC, Schaumburg, IL (US)

(72) Inventors: Dominic William Douglas, Ballycastle (GB); Raymond McClurg, Belfast (GB); Barry Gerard Gray, Belfast (GB); Joel Andrew Samuel Brown, Ballymena (GB)

(21) Appl. No.: 19/671,614

(22) Filed: May 8, 2026

Related U.S. Application Data
(63) Continuation of application No. PCT/US2023/079079, filed on Nov. 8, 2023.

(51) Int. Cl. B60C 23/04; B60C 29/00; G01L 17/00

(52) U.S. Cl. CPC B60C 23/0496; B60C 29/00; G01L 17/00

(57) ABSTRACT

Embodiments included herein are directed towards manufacturing an apparatus included within a Tire Pressure Monitoring System (TPMS), and related methods. Embodiments of the present disclosure may include an integrated valve core depressor. The integrated valve core depressor may be part of a single component which both couples to and depresses a valve core of a tire valve.

### CROSS-REFERENCE TO RELATED APPLICATION

This application is a continuation of and claims the benefit of and priority to international Application No. PCT/US2023/079079, filed on Nov. 8, 2023, all the content of which is hereby incorporated by reference in their entirety.

### TECHNICAL FIELD

The present disclosure generally applies to monitoring sensors, more specifically system and method for a core depressor in a tire pressure monitoring system sensor.

### BACKGROUND

Measurements of tire pressure in the individual wheel assemblies of a vehicle undergoing a vehicle service procedure may be useful in determining vehicle measurements and/or the proper operation of a vehicle-mounted tire pressure monitoring system (“TPMS”). Tire pressure monitoring systems are electrical systems designed to monitor the air pressure inside the tires of vehicles. These systems generally operate in real-time periodically measuring tire pressure to help avoid traffic accidents, poor fuel economy, and improve wear on the tires. Numerous countries around the world mandate these systems in vehicles because of their effectiveness in creating a safer driving environment.

Overall height of external tire pressure monitoring system sensors is a key requirement from customers. Reduced height means less protrusion of a sensor of the tire pressure monitoring system beyond a wheel rim which in turn reduces the possibility of curb strike (a curb strike is when the vehicle tire contacts the curb) and therefore reduces the possibility of sensor and/or tire valve damage.

Reduced overall height also aids reduction of G loading on the tire valve from centrifugal forces which may help with both fatigue of the tire valve and wheel balancing. Some sensors include two-piece brass inserts with core depressor fitted as a separate component, and/or a central through hole for air to contact a sense element.

### SUMMARY OF THE DISCLOSURE

As will be discussed in greater detail below, embodiments included herein are directed towards manufacturing an apparatus included within a Tire Pressure Monitoring System (TPMS), and related methods. Embodiments of the present disclosure may include an integrated valve core depressor. The integrated valve core depressor may be part of a single component which both couples to and depresses a valve core of a tire valve.

Some or all of the following features may be included. The integrated valve core depressor may include a first hole located on a valve core side of the tire valve. The integrated valve core depressor may include a second hole located on a sensor core side of the tire valve. The second hole machined on the sensor core side may have a larger diameter than the first hole machined on the valve core side. The first hole from the valve core side may mate with the second hole from the sensor core side to generate a path for a pressure to contact with a sense element of a sensor. The second hole machined on the sensor side may be a blind machined hole. The integrated valve core depressor may be manufactured from a single piece of brass. The integrated valve core depressor may be configured to minimize a stack height between an end of the tire valve and the sense element.

In an embodiment, a method of an integrated valve core depressor in a TPMS may include manufacturing the integrated valve core depressor as a single component which both couples to and depresses a valve core of a tire valve. The method may further include placing an internal boss central to a threaded coupling. The method may further include machining the internal boss from a first side of a tire valve and a second side of the tire valve. The method may further include offsetting a hole, formed by machining on the first side of the tire valve, from center to generate a sufficient contact area for a valve core pin to contact and be depressed when the threaded coupling may be threaded onto a valve core of the tire valve.

Some or all of the following features may be included. The method may include mating the hole from the first side of the tire valve with a larger diameter blind machined hole from the second side of the tire valve. Offsetting the hole at the first side of the tire valve may prevent the valve core pin from blocking an airway to a sensor. Mating the hole from the first side of the tire valve with a larger diameter blind machined hole from the second side of the tire valve may include generating a path for a pressure to contact with a sense element of the sensor. The first side may be a valve core side of the tire valve. The second side may be a sensor side of the tire valve. The integrated valve core depressor may be manufactured from a single piece of brass. The integrated valve core depressor may be configured to minimize a stack height between an end of the tire valve and the sense element.

In one or more embodiments of the present disclosure, a TPMS system is provided. The TPMS system (also known as an external tire pressure monitor system) may include a valve core with an integrated valve core depressor. The TPMS system may further include a sealing grommet. The TPMS system may further include a valve nut. The TPMS system may further include a tire valve with a valve stem. The TPMS system may further include a valve core pin The TPMS system may further include a sensor with a sense element. The integrated valve core depressor may be configured to place an internal boss central to a threaded coupling. The integrated valve core depressor may be further configured to machine the internal boss from a first side of the tire valve and a second side of the tire valve. The integrated valve core depressor may be further configured to offset a hole, formed by machining on the first side of the tire valve, from center to generate a sufficient contact area for the valve core pin to contact and be depressed when the threaded coupling is threaded onto the valve core of the tire valve. The integrated valve core depressor may be part of a single component which both couples to and depresses the valve core of the tire valve.

Some or all of the following features may be included. The integrated valve core depressor may be further configured to mate the hole from the first side of the tire valve with a larger diameter blind machined hole from the second side of the tire valve. Offsetting the hole at the first side of the tire valve may prevent the valve core pin from blocking an airway to the sensor. The integrated valve core depressor may be further configured to generate a path for a pressure to contact with the sense element of the sensor. The first side may be a valve core side of the tire valve and the second side may be a sensor side of the tire valve. The integrated valve core depressor may be manufactured from a single piece of brass. The integrated valve core depressor may be configured to minimize a stack height between an end of the tire valve and the sense element.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

This summary is provided to introduce a selection of concepts that are further described below in the detailed description. This summary is not intended to identify essential features of the claimed subject matter, nor is it intended to be used as an aid in limiting the scope of the claimed subject matter.

### BRIEF DESCRIPTION OF THE DRAWINGS

Embodiments of the present disclosure are described with reference to the following figures.

FIGS. 1A-1C are diagrammatic views of a Tire Pressure Monitoring System (TPMS) and a valve core with an integrated valve core depressor coupled to tires of a vehicle in accordance with embodiments of the present disclosure;

FIG. 2A illustrates example components of the TPMS in accordance with embodiments of the present disclosure;

FIG. 2B illustrates example components of the valve core in accordance with embodiments of the present disclosure;

FIG. 2C illustrates isometric view of the valve core in accordance with embodiments of the present disclosure;

FIG. 3 is a schematic illustrating an internal view of the integrated valve core depressor in accordance with embodiments of the present disclosure;

FIG. 4 is a focused schematic of FIG. 3 illustrating example components of the integrated valve core depressor in accordance with embodiments of the present disclosure; and

FIG. 5 is a flowchart illustrating example operations in accordance with embodiments of the present disclosure.

Like reference symbols in the various drawings may indicate like elements.

### DETAILED DESCRIPTION

The discussion below is directed to certain implementations. It is to be understood that the discussion below is only for the purpose of enabling a person with ordinary skill in the art to make and use any subject matter defined now or later by the patent “claims” found in any issued patent herein.

It is specifically intended that the claimed combinations of features not be limited to the embodiments and/or implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered a same object or step.

Embodiments of the present disclosure may include an integrated valve core depressor. The integrated valve core depressor may be part of a single component which both couples to and depresses a valve core of a tire valve.

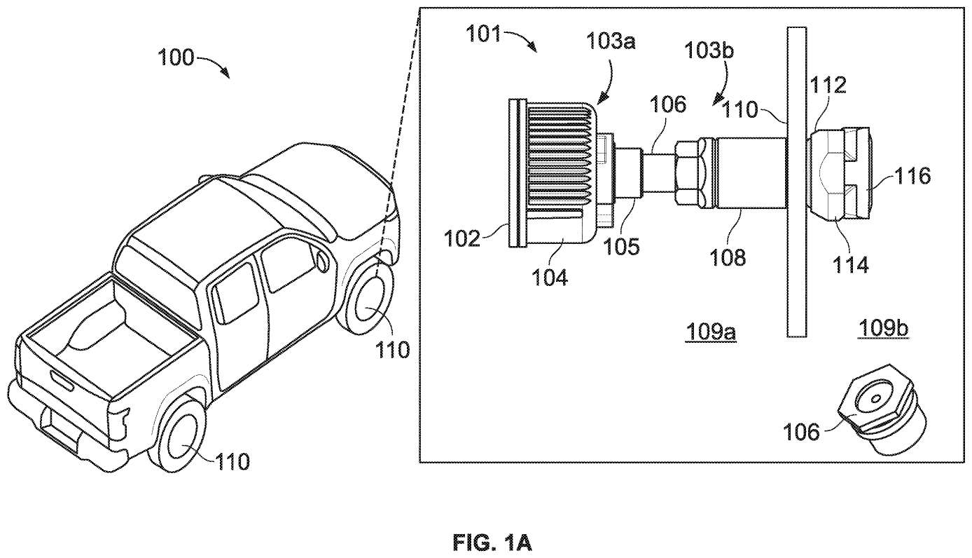

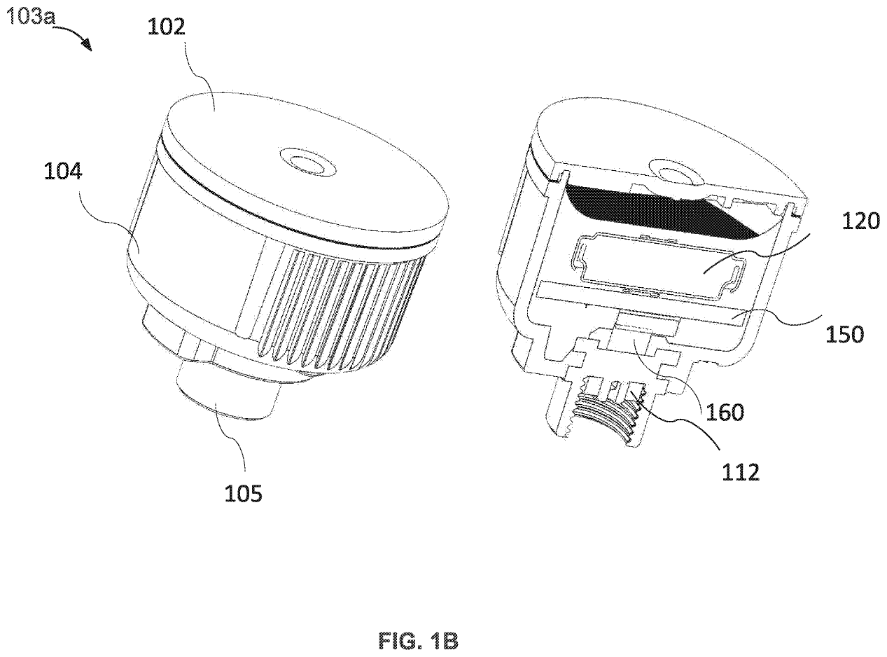

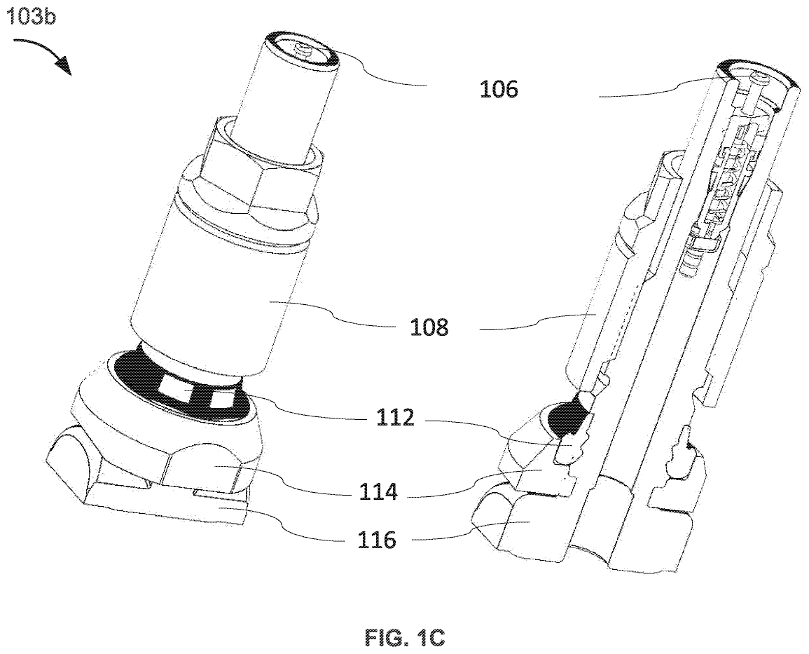

Referring now to FIG. 1A, a diagram illustrating example components of a vehicle 100 is shown. In some embodiments, vehicle 100 may include a dedicated tire pressure monitoring system (“TPMS”) 101 which may be configured with a suitable or supplemental sensor (shown in FIG. 1B) adapted to acquire direct measurements of the air pressure in one or more of tires 110 of the vehicle 100 undergoing a service procedure. TPMS 101 may have many mechanical parts an outside tire 109a and an inside tire 109b for a valve stem 116 and air-tight tire mounting with all electronics in a sealed module of an assembly with an upper section 103a (shown in FIG. 1B) and a lower section, for example, a tire valve 103b (shown in FIG. 1C).

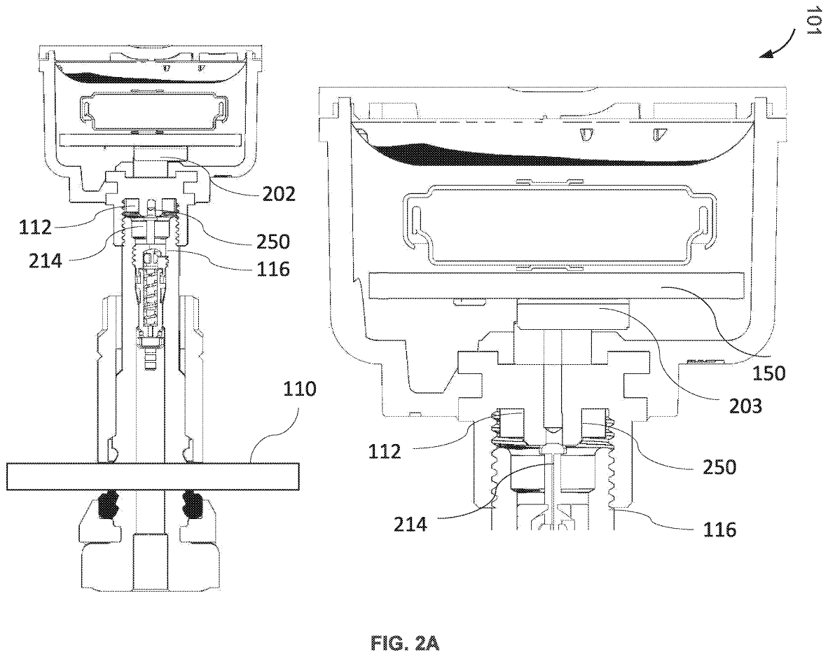

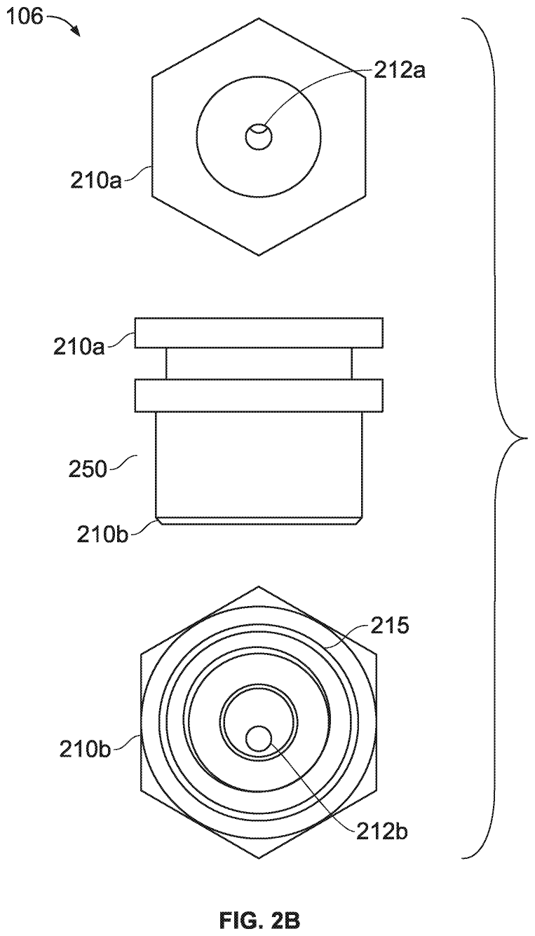

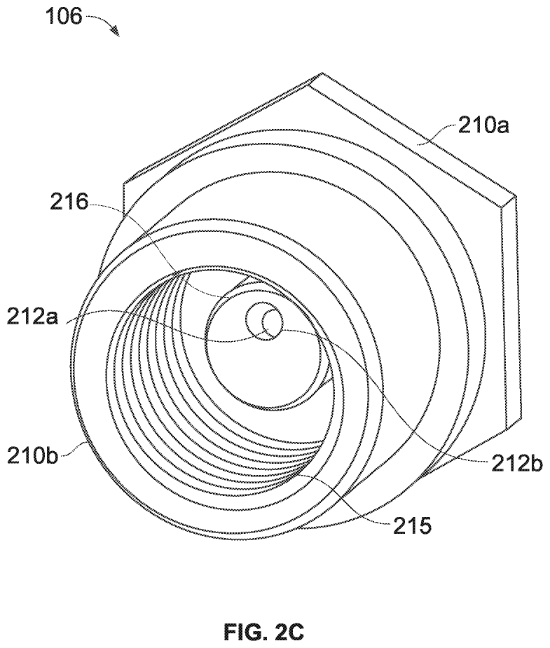

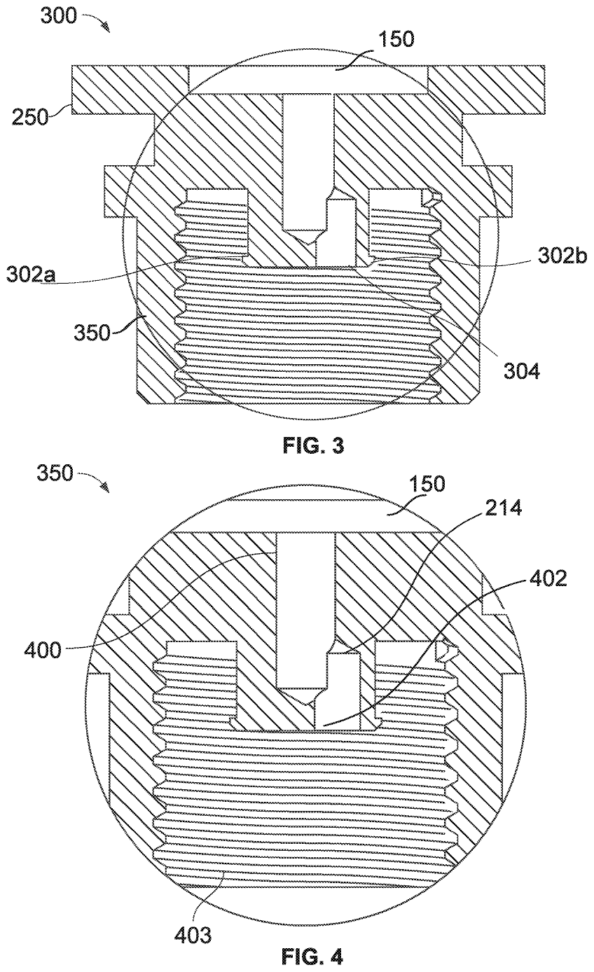

In some embodiments, TPMS 101 may be further connected to outside tire 109a with tire 110 using a lid 102, an enclosure 104, an over molded nut 105, a valve core 106, and a valve nut 108. In some embodiments, TPMS 101 may be further connected to inside tire 109a with valve stem 116 and tire 110 using a sealing grommet 112 and a valve seat 114. Further, the TPMS system may include a valve core pin (shown in FIG. 2A). In some embodiments, valve core 103b may include an integrated valve core depressor (shown in FIG. 3)

Regardless of the valve type, valve core 106 is the fundamental sealing device and may snugly screw into a valve core chamber. Valve core 106 may come in short and long lengths, with the short length being preferred for high performance applications.

In some embodiments, both nickel-plated and brass valve cores 106 are available. The nickel-plated valve cores 106 must be used in the aluminum valve stems 116 of TPMS 101. All valve cores 106 may feature sealing grommet 112 attached to a movable, spring-loaded pin that allows pressurized air to pass when inflating tire 110, as well as air to escape when the pin may be depressed to unseat sealing grommet 112. While valve core 106 in general may accept a working pressure of 300 psi, it is important to protect them from grit, sand, and moisture. Grit and sand might prevent valve core 106 from sealing completely, and moisture may freeze in cold temperatures and defeat sealing grommet 112.

In some embodiments, high-speed pressure loss and core contamination are several of the reasons why valve caps should always be used. In the event that anything disrupts sealing grommet 112, the cap may provide a backup seal that prevents air from escaping. In some embodiments, various types of valve caps may be employed. For example, plastic dome, metal dome and/or a metal “screwdriver” design of the valve cap may be used to tighten and loosen the valve core (e.g., valve core 106).

In some embodiments, example features and/or possible example advantages may include a single piece core depressor feature of the integrated valve core depressor (integrated valve core depressor 250 as shown in FIG. 3) of valve core 106 within the brass insert design which may provide benefits in terms of cost, reduction of component count to the absolute minimum, simplification of an assembly process, and minimization of a stack height between an end of tire valve 103b and a sense element (shown in FIG. 2A).

Referring to FIG. 1B, a diagram illustrating example components of upper section 103a of TPMS 101 shown in FIG. 1A in accordance with embodiments of the present disclosure is shown. In some embodiments, upper section 103a of TPMS 101 may include lid 102, enclosure 104, and over molded nut 105, a valve core 106, and a valve nut 108. In some embodiments, enclosure 104 may further include a potting 120, a sensor 150, a PIM seal 160, and sealing grommet 112. In some embodiments, sensor 150 (e.g., pressure sensor/ASICs (Application Specific ICs)) may be of any conventional design intended to provide a signal representative of a measure of air pressure in individual tires 110 or wheel assemblies of vehicle 100. Sensor 150 may include both mechanical and/or electronic components. The mechanical sensors may use a diaphragm and a spring to sense the pressure changes. In contrast, the electronic sensors use a battery-powered device that transmits a signal to the vehicle's onboard computer. Furthermore, TPMS sensors 150 may be normally sealed. In electronics, potting is a process of filling a complete electronic assembly with a solid or gelatinous compound for resistance to shock and vibration, and for exclusion of moisture and corrosive agents. In some embodiments, thermo-setting plastics or silicone rubber gels may be often used for potting 120 in TPMS 101.

In some embodiments, PIM seal 160 may be PIM Shield® Paint and PIM Seal™ Caulk which may be a liquid RF barrier product or a thick, conductive acrylic polymer with enhanced elasticity designed to reduce external passive intermodulation (PIM) at cellular base stations. PIM seal 160 may be applied directly to metal interfaces on electronics mounting frames of TPMS 101 to block RF energy from reaching non-linear junctions to reduce PIM.

Referring to FIG. 1C, a diagram illustrating example components of tire valve 103b of TPMS 101 shown in FIG. 1A in accordance with embodiments of the present disclosure is shown. In some embodiments, tire valve 103b of TPMS 101 may include valve core 106, valve nut 108, sealing grommet 112, valve seat 114, and valve stem 116 which are described above with respect to FIG. 1A. More details of processing operations are provided below in reference to the other figures. Specifically, referring to FIGS. 2-4, schematics illustrating example components and different views of integrated valve core depressor of valve core 106 are shown.

Referring to FIG. 2A, a diagram illustrating example components of the TPMS 101 shown in FIGS. 1B and 1C in accordance with embodiments of the present disclosure is shown. In some embodiments, the components of FIG. 2A may include sensor 150 with a sense element (shown in FIG. 2A). Sensor 150 may measure the air pressure and temperature of tires 110 and sends these data signals, acquired directly via sense element 203 by an interface of TPMS 101, wirelessly to an onboard computer of vehicle 100. The computer compares the information to the recommended tire pressure for vehicle 100. If the pressure in one or more tires is too low, the computer may signal the driver via a warning light on the dashboard. Those of ordinary skill in the art may recognize that this procedure may be completed in an automated fashion by vehicle 100.

In some embodiments, the components of FIG. 2A may include a valve core pin 214 and an integrated valve core depressor 250. Integrated valve core depressor 250 may be part of a single component which both couples to and depresses valve core 106 of tire valve 103b (as shown in FIGS. 1A and 1C). For example, an overall height of integrated valve core depressor 250 may be approximately 9.85 mm±0.1.

Referring to FIG. 2B, a diagram illustrating example components of valve core 106 in accordance with embodiments of the present disclosure is shown. The components of FIG. 2B may include integrated valve core depressor 250 which may be comprised of a sensor core side 210a and a valve core side 210b. Valve core side 210b may be a first side of tire valve 112. Sensor core side 210a may be a second side of tire valve 112. In some embodiments, integrated valve core depressor 250 may be configured to place an internal boss central (shown in FIG. 2C as 216) to a threaded coupling (shown in FIG. 2B as 215) and machine internal boss 216 from the first side of tire valve (valve core side 210b) and the second side of the tire valve (sensor core side 210a).

In some embodiments, a hole 212b may be formed by machining on the first side of the tire valve (valve core side 210b). This hole may be offset from the center to generate a sufficient contact area for the valve core pin (shown in FIG. 4 as 214) to contact and be depressed when the threaded coupling (shown in FIG. 2B as 215) may be threaded onto valve core 106 of tire valve 112. Integrated valve core depressor 250 may be further configured to mate hole 212b from the first side of the tire valve (valve core side 210b) with a larger diameter blind machined hole 212a from the second side of the tire valve (sensor core side 210a). For example, hole 212b from the first side of the tire valve (valve core side 210b) may be approximately 3.9 mm. In some embodiments, integrated valve core depressor 250 may be further configured to generate a path for a pressure to contact with sense element 203 of sensor 150 (shown in FIG. 2A).

In some embodiments, integrated valve core depressor 250 may be manufactured from a single piece of brass. Thus, utilizing a single piece brass insert for manufacturing integrated valve core depressor 250 may lead to reduction of component count and simplification of an assembly process to fit a core depressor of valve core 106 to the brass insert. In some embodiments, integrated valve core depressor 250 may be configured to minimize a stack height between an end of tire valve 112 and sense element 103 (of sensor 102).

Referring to FIGS. 1A-1C, 2A, and 2B, in some embodiments, as TPMS 101 is screwed onto tire valve 103b, sealing grommet 112 may contact the end of valve stem 116 forming a seal at the same time the integrated valve core depressor 250 may contact valve core pin 214 of tire valve core 106 releasing the pressure from inside the tire assembly of vehicle 100.

Referring to FIG. 2C, an isometric view of valve core 106 in accordance with embodiments of the present disclosure is shown. FIG. 2C illustrates the isometric view of valve core 106 as compared to FIG. 2B. For example, an internal boss 216 placed centrally to threaded coupling 215 and offsetting hole 212b at first side of the tire valve 210b are shown. The internal boss 216 is a protruding feature located on a front face mating part of valve core 106 that may receive a screw or thread-forming screw. Offsetting hole 212b at first side of the tire valve 210b may prevent a valve core pin (shown in FIG. 4) from blocking an airway to sensor 102. In some embodiments, the dimension of the internal boss may be approximately 3.55 mm±0.05. The components of FIGS. 2A and 2B are shown for illustrative purposes only and are not intended to limit the present disclosure.

Referring to FIG. 3, a schematic illustrating an internal view of integrated valve core depressor 250 in accordance with embodiments of the present disclosure is shown. FIG. 3 illustrates an internal view of integrated valve core depressor 250 of valve core 106 (as shown in FIG. 1A). In some embodiments, chamfers on both edges 302a and 302b of integrated valve core depressor 250 may be approximately of size 0.2 mm. Further, an undercut 304 of diameter 3.5 mm may be added to integrated valve core depressor 250. A detailed internal view of a focused schematic 350 illustrating components of integrated valve core depressor 250 is shown in FIG. 4.

Referring now to FIG. 4, focused schematic 350 of FIG. 3 illustrating example components of integrated valve core depressor 250 in accordance with embodiments of the present disclosure is shown. The components of integrated valve core depressor 250 shown in focused schematic 350 may include a sensor core side 400 near sensor 150 and a valve core side 402 with threads 403. In some embodiments, valve core side 402 has valve core pin 214 which may be approximately of size 1.95 mm±0.1. In some embodiments, integrated valve core depressor 250 may include a first hole 212b (shown in FIGS. 2B and 2C) machined on valve core side 402 of the tire valve. Integrated valve core depressor 250 may include a second hole 212a (shown in FIGS. 2B and 2C) located on sensor core side 400 of the tire valve.

In some embodiments, second hole 212a machined on sensor core side 400 may have a larger diameter than first hole 212b machined on valve core side 402. For example, second hole 212a may approximately have diameter 3.9 mm±0.1, while first hole 212b may approximately have diameter 1.2 mm±0.1. First hole 212b from valve core side 402 may mate with second hole 212a from sensor core side 400 to generate a path for a pressure to contact with sense element 203 of sensor 150. Second hole 212a machined on sensor side 400 may be a blind machined hole. The blind machined hole is a hole drilled to a certain depth. In some embodiments, second hole 212a may approximately have a depth 1.95 mm±0.1.

In some embodiments, integrated valve core depressor 250 may be manufactured from a single piece of brass. The quality of the brass material used is typically brass CZ121 and should have no material inclusions, pinholes, segregations, cracks or discoloring visible in any cross-section when view at 5× magnification. The quality of the manufacturing material is mentioned for illustrative purposes only and are not intended to limit the present disclosure.

In some embodiments, a single piece core depressor feature of integrated valve core depressor 250 within the brass insert design may provide benefits in terms of cost, reduction of component count to the absolute minimum, simplification of an assembly process, and minimization of a stack height between an end of the tire valve and the sense element.

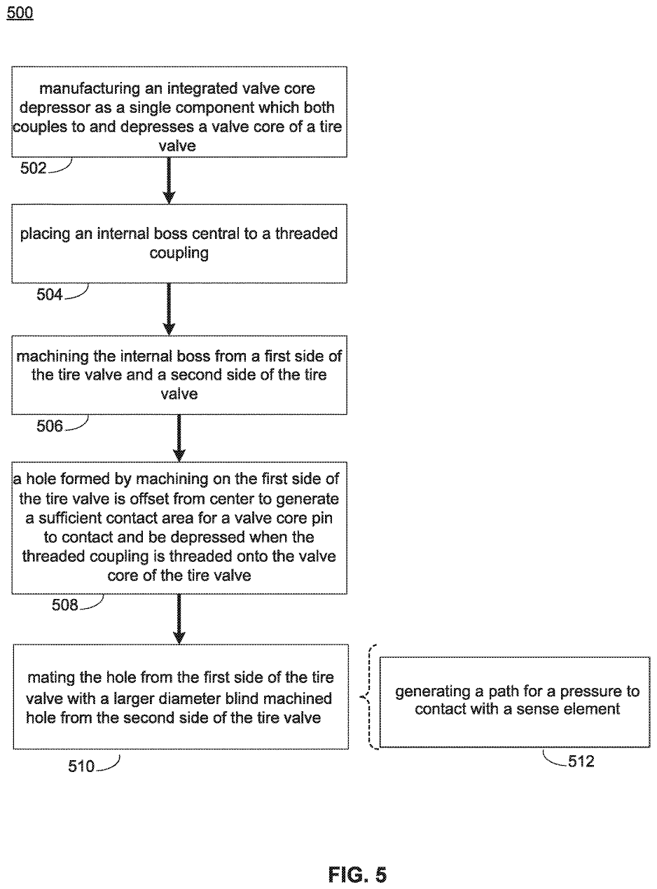

Referring now to FIG. 5, a flowchart illustrating example operations in accordance with embodiments of the present disclosure is shown. A method 500 may include manufacturing (502) an integrated valve core depressor (e.g., integrated valve core depressor 250 of FIG. 2B) as a single component which both couples to and depresses (502) a valve core (e.g., valve core 106 of FIG. 1A) of a tire valve (e.g., tire valve 103b of FIG. 1A). The method 500 may further include placing (504) an internal boss (e.g., internal boss 216 of FIG. 2C) central to a threaded coupling (e.g., threads 403 of FIG. 4). The method 500 may further include machining (506) the internal boss from a first side of the tire valve (e.g., valve core side 210b of FIG. 2B) and a second side of the tire valve (e.g., sensor core side 210a of FIG. 2B).

In embodiments, the method 500 may include offsetting (508) a hole (e.g., first hole 212b of FIG. 2B), formed by machining on the first side of the tire valve (e.g., valve core side 210b), from center to generate a sufficient contact area for a valve core pin (e.g., valve core pin 214 of FIG. 2A) to contact and be depressed when the threaded coupling (e.g., threads 403) may be threaded onto the valve core (e.g., valve core 106) of the tire valve (e.g., tire valve 103b). The method 500 may further include mating (510) the hole (e.g., first hole 212b) from the first side of the tire valve (e.g., valve core side 210b) with a larger diameter blind machined hole (e.g., second hole 212a of FIG. 2B) from the second side of the tire valve (e.g., sensor core side 210a). Offsetting the hole (e.g., first hole 212b) at the first side of the tire valve (e.g., valve core side 210b) may prevent the valve core pin (e.g., valve core pin 214) from blocking an airway to a sensor (e.g., sensor 150 of FIG. 1B). The method 500 may further include generating (512) a path for a pressure to contact with a sense element (e.g., sensor element 203) of the sensor (e.g., sensor 150).

As discussed above with regard to FIGS. 2A and 2B, the first side may be a valve core side of the tire valve (e.g., valve core side 210b) and the second side may be a sensor side of the tire valve (e.g., sensor core side 210a). In some embodiments, the integrated valve core depressor (e.g., integrated valve core depressor 250) may be manufactured from a single piece of brass. The integrated valve core depressor (e.g., integrated valve core depressor 250) may be configured to minimize a stack height between an end of the tire valve (e.g., tire valve 103b) and the sense element (e.g., sensor element 203).

The terminology used herein is for the purpose of describing particular embodiments and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the scope of the present disclosure, described herein. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph (f) for any limitations of any of the claims herein, except for those in which the claim expressly uses the words ‘means for’ or ‘step for’ together with an associated function.

Having thus described the disclosure of the present application in detail and by reference to embodiments thereof, it will be apparent that modifications and variations are possible without departing from the scope of the disclosure defined in the appended claims.

1. An apparatus included within a tire pressure monitoring system (“TPMS”), comprising:
an integrated valve core depressor,
wherein the integrated valve core depressor is part of a single component which both couples to and depresses a valve core of a tire valve.

2. The apparatus of claim 1, wherein the integrated valve core depressor includes a first hole located on a valve core side of the tire valve.

3. The apparatus of claim 2, wherein the integrated valve core depressor includes a second hole located on a sensor core side of the tire valve and wherein the second hole machined on the sensor core side has a larger diameter than the first hole machined on the valve core side.

4. The apparatus of claim 3, wherein the first hole from the valve core side mates with the second hole from the sensor core side to generate a path for a pressure to contact with a sense element of a sensor.

5. The apparatus of claim 1, wherein the second hole machined on the sensor side is a blind machined hole.

6. The apparatus of claim 1, wherein the integrated valve core depressor is manufactured from a single piece of brass.

7. The apparatus of claim 4, wherein the integrated valve core depressor is configured to minimize a stack height between an end of the tire valve and the sense element.

8. A method of an integrated valve core depressor in a TPMS, comprising:
manufacturing the integrated valve core depressor as a single component which both couples to and depresses a valve core of a tire valve;
placing an internal boss central to a threaded coupling;
machining the internal boss from a first side of the tire valve and a second side of the tire valve; and
offsetting a hole, formed by machining on the first side of the tire valve, from center to generate a sufficient contact area for a valve core pin to contact and be depressed when the threaded coupling is threaded onto the valve core of the tire valve.

9. The method of claim 8, further comprising:
mating the hole from the first side of the tire valve with a larger diameter blind machined hole from the second side of the tire valve,
wherein offsetting the hole at the first side of the tire valve prevents the valve core pin from blocking an airway to a sensor.

10. The method of claim 9, wherein mating the hole from the first side of the tire valve with a larger diameter blind machined hole from the second side of the tire valve includes:
generating a path for a pressure to contact with a sense element of the sensor.

11. The method of claim 8, wherein the first side is a valve core side of the tire valve.

12. The method of claim 8, wherein the second side is a sensor side of the tire valve.

13. The method of claim 8, wherein the integrated valve core depressor is manufactured from a single piece of brass.

14. The method of claim 10, wherein the integrated valve core depressor is configured to minimize a stack height between an end of the tire valve and the sense element.

15. A TPMS system comprising:
a valve core with an integrated valve core depressor;
a sealing grommet;
a valve nut;
a tire valve with a valve stem;
a valve core pin; and
a sensor with a sense element,
wherein the integrated valve core depressor is configured to:
place an internal boss central to a threaded coupling; and
machine the internal boss from a first side of the tire valve and a second side of the tire valve,
wherein a hole formed by machining on the first side of the tire valve is offset from center to generate a sufficient contact area for the valve core pin to contact and be depressed when the threaded coupling is threaded onto the valve core of the tire valve, and
wherein the integrated valve core depressor is part of a single component which both couples to and depresses the valve core of the tire valve.

16. The TPMS system of claim 15, wherein the integrated valve core depressor is further configured to:
mate the hole from the first side of the tire valve with a larger diameter blind machined hole from the second side of the tire valve,
wherein offsetting the hole at the first side of the tire valve prevents the valve core pin from blocking an airway to the sensor.

17. The TPMS system of claim 16, wherein the integrated valve core depressor is further configured to:
generate a path for a pressure to contact with the sense element of the sensor.

18. The TPMS system of claim 15, wherein the first side is a valve core side of the tire valve and the second side is a sensor side of the tire valve.

19. The TPMS system of claim 15, wherein the integrated valve core depressor is manufactured from a single piece of brass.

20. The TPMS system of claim 17, wherein the integrated valve core depressor is configured to minimize a stack height between an end of the tire valve and the sense element.
